(19) United States
(12) Patent Application Publication
(10) Pub. No.: US 2026/0368276 A1
(43) Pub. Date: Nov. 19, 2026

(54) METHOD FOR CLUSTER EVALUATION, ELECTRONIC DEVICE, AND STORAGE MEDIUM

(71) Applicant: MASHANG CONSUMER FINANCE CO., LTD., Chongqing (CN)

(72) Inventors: Changlin LI, Chongqing (CN); Zhengpeng HAO, Chongqing (CN); Lei CAO, Chongqing (CN)

(21) Appl. No.: 19/343,705

(22) Filed: Sep. 29, 2025

(30) Foreign Application Priority Data
May 16, 2025 (CN) 202510638972.1

(51) Int. Cl. G06F 18/21; G06F 18/22; G06F 18/23; G06F 18/25

(52) U.S. Cl. CPC G06F 18/2178; G06F 18/22; G06F 18/23; G06F 18/254

(57) ABSTRACT

A method and apparatus for cluster evaluation includes: a clustering operation is performed on multiple sample data to obtain multiple first clusters; for each first sample data from the multiple sample data, second sample data whose similarity with the first sample data is greater than a first threshold value is determined from the multiple sample data; a confidence of the clustering operation corresponding to each first sample data is determined based on a distribution of the second sample data in each of the first clusters; and the clustering operation is evaluated based on the confidence corresponding to each first sample data to obtain an evaluation value.

### CROSS-REFERENCE TO RELATED APPLICATION

This application claims the benefit of priority of Chinese Patent Application No. 202510638972.1 filed on May 16, 2025, the contents of which are incorporated herein by reference in its entirety for all purposes.

### BACKGROUND

With rapid development of the computer technology, massive data can be processed and analyzed by computers. As an important data processing means, the clustering technology plays a key role. Based on attributes of sample data and their relationship, clustering processing classifies sample data with a high similarity into a same cluster, and allocates sample data with a low similarity into different clusters, thus forming multiple clusters with inherent consistency. The evaluation of clustering performance is an important link to measure quality of a clustering result, guide optimization of a clustering algorithm and verify clustering validity.

### SUMMARY

Embodiments of the present disclosure provide a method for cluster evaluation, an electronic device, and a non-transitory storage medium.

The technical solutions of the embodiments of the present disclosure are implemented as follows.

The embodiments of the present disclosure provide a method for cluster evaluation, including: performing a clustering operation on a plurality of sample data to obtain a plurality of first clusters; for each first sample data from the plurality of the sample data, determining second sample data whose similarity with the first sample data is greater than a first threshold value from the plurality of the sample data; determining a confidence of the clustering operation corresponding to each first sample data based on a distribution of the second sample data in each of the first clusters; and evaluating the clustering operation based on the confidence corresponding to each first sample data to obtain an evaluation value.

The embodiments of the present disclosure provide an electronic device, including: a memory, configured to store computer-executable instructions or computer programs; and the processor is configured to execute the computer-executable instructions to perform operations of: performing a clustering operation on a plurality of first sample data to obtain a plurality of first clusters; for each first sample data from the plurality of the sample data, determining second sample data whose similarity with the first sample data is greater than a first threshold value from the plurality of the sample data; determining a confidence of the clustering operation corresponding to each first sample data based on a distribution of the second sample data in each of the first clusters; and evaluating the clustering operation based on the confidence corresponding to each first sample data to obtain an evaluation value.

The embodiments of the present disclosure provide a non-transitory computer-readable storage medium having stored thereon computer-executable instructions that, when executed by a processor, cause the processor to perform operations of: performing a clustering operation on a plurality of first sample data to obtain a plurality of first clusters; for each first sample data from the plurality of the sample data, determining second sample data whose similarity with the first sample data is greater than a first threshold value from the plurality of the first sample data; determining a confidence of the clustering operation corresponding to each first sample data based on a distribution of the second sample data in each of the first clusters; and evaluating the clustering operation based on the confidence corresponding to each first sample data to obtain an evaluation value.

### BRIEF DESCRIPTION OF THE DRAWINGS

FIG. 1 is a schematic structural diagram of an architecture of a system for cluster evaluation according to an embodiment of the present disclosure.

FIG. 2 is a schematic structural diagram of an electronic device for cluster evaluation according to an embodiment of the present disclosure.

FIG. 3 is a first schematic flowchart of a method for cluster evaluation according to an embodiment of the present disclosure.

FIG. 4 is a second schematic flowchart of a method for cluster evaluation according to an embodiment of the present disclosure.

FIG. 5 is a third schematic flowchart of a method for cluster evaluation according to an embodiment of the present disclosure.

FIG. 6 is a fourth schematic flowchart of a method for cluster evaluation according to an embodiment of the present disclosure.

It is to be pointed out that the above-mentioned “first” and “second” are only used to distinguish different schemes, and they are not used to indicate that one scheme is superior or inferior to another scheme, or to indicate the priority in the implementation process.

### DETAILED DESCRIPTION

To make the objectives, technical solutions, and advantages of the present disclosure clearer, the present disclosure will be described in further detail below with reference to the drawings. The described embodiments should not be regarded as limiting the present disclosure. All other embodiments that are obtained by those of ordinary skill in the art without involving creative efforts fall within the scope of protection of the present disclosure.

When the following description refers to “some embodiments”, the phrasing describes a subset of all possible embodiments, but it can be understood that “some embodiments” may be the same subset or different subsets of all possible embodiments, and may be combined with each other without conflict.

The term “first\second\third” as referred to in the following description is only to distinguish similar objects, and does not represent a specific ordering of objects. It can be understood that the specific order or sequential order of “first\second\third” may be interchanged if allowed, so that the embodiments of the present disclosure described herein can be implemented in an order other than those illustrated or described herein.

In the embodiments of the present disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. Furthermore, each module or unit may be a part of an integral module or unit that includes the functionality of the module or unit.

Unless otherwise defined, all technical and scientific terms used in the embodiments of the present disclosure have the same meanings as commonly understood by a person of ordinary skill in the technical field to which the present disclosure belongs. The terms used in the embodiments of the present disclosure are only for the purpose of describing the embodiments of the present disclosure, and are not intended to limit the present disclosure.

In the embodiments of the present disclosure, the relevant data collection processing, when applied to examples, should strictly obtain informed consent or separate consent for the personal information subject according to the requirements of relevant laws and regulations, and carry out subsequent data use and processing within the scope of the laws and regulations and the authorization of the personal information subject.

Before the embodiments of the present disclosure are further described in detail, the nouns and terms referred to in the embodiments of the present disclosure are illustrated. The nouns and terms referred to in the embodiments of the present disclosure are applicable to the following explanations.

1) Clustering is an unsupervised learning algorithm. It automatically classifies sample data into different clusters by analyzing intrinsic characteristics of the sample data. The clusters are independent groups formed during the clustering process. Within a same cluster, sample data thereof have high similarity, and the similarity is reflected in the fact that the sample data are similar in terms of their eigenvalues, patterns or structures. On the contrary, the similarity between sample data of different clusters is low. The core goal of the clustering algorithm is to discover a natural grouping structure in a sample data set, thus providing a basis for further analysis, classification or visualization of the sample data.

2) Clustering performance is a key indicator to measure a clustering result. It evaluates the validity and accuracy of a clustering operation through a series of quantitative methods and standards. The clustering performance not only determines the reliability of the clustering result, but also directly affects the usability of the clustering result in practical applications. Good clustering performance means that the clustering result can clearly reveal the internal structure of data, so that sample data in a same cluster have high similarity, while sample data of different clusters have obvious differences.

3) Seed point sample data is representative sample data pre-selected in a clustering task, which is used to initialize a cluster center and guide the clustering operation to converge more efficiently and accurately. The seed point sample data can be labeled manually, or automatically selected by a specific strategy (e.g., density peak, farthest point sampling, or based on information entropy), where the cluster center is a core point or representative point of each cluster, which reflects a centralized trend and characteristics of all sample data in the cluster.

4) A neural network model is a computational model based on artificial neural network structure, which is widely used in fields such as data classification, regression analysis, image recognition and natural language processing. It can automatically learn complex patterns and relationships in data by simulating structures and functions of biological neural networks. The neural network model usually consists of an input layer, a hidden layer and an output layer, and weights between neurons are adjusted through a training process to achieve effective processing of input data and prediction.

In the related art, depending on whether the sample data contains labeled data, the methods for cluster evaluation can be divided into two categories: one is an evaluation method based on external metrics, and the other is an evaluation method based on internal metrics. The evaluation method based on external metrics refers to a method for determining clustering performance by comparing clustering results with labeled data, and the metrics include: Rand Index (RI), adjusted RI, adjusted mutual information index, etc. Because the implementation of the evaluation method based on external metrics depends on the labeled information of sample data, this method is difficult to be applied in practice. The evaluation method based on internal metrics refers to a method for determining whether a clustering result is good or not based on the analysis of clustering result, and the metrics include: silhouette coefficient, variance ratio criterion, Davies-Bouldin index, etc. The evaluation method based on the internal metrics focuses on the global structure of a clustering result and ignores local details (that is to say, the clustering performance is evaluated only by compactness of a cluster and a separation degree between clusters), and can't capture the influence of each sample data on clustering performance, and is sensitive to noise and outliers, which makes the evaluation accuracy of the clustering performance low.

Embodiments of the present disclosure provide a method and apparatus for cluster evaluation, an electronic device, a storage medium and a computer program product, which can implement more comprehensive evaluation of the clustering performance.

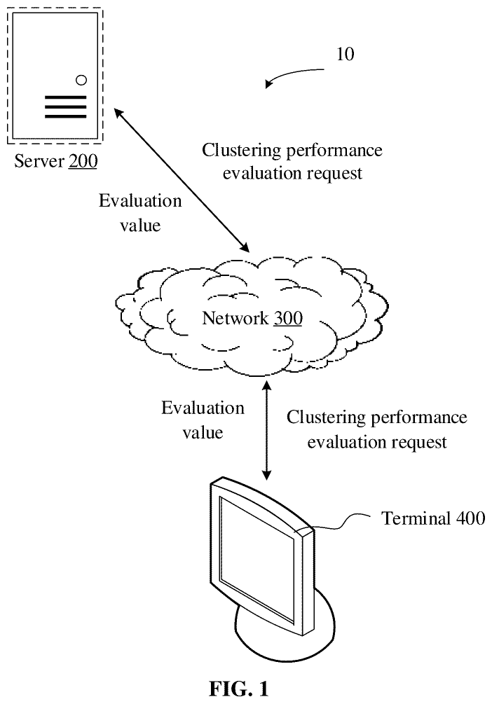

Referring to FIG. 1, FIG. 1 is a schematic structural diagram of an architecture of a system for cluster evaluation according to an embodiment of the present disclosure. In the system 10 for cluster evaluation according to the embodiment of the present disclosure, in order to implement an application supporting evaluation of clustering performance, the terminal 400 is connected to the server 200 through a network 300, and the network 300 may be a wide area network or a local area network, or a combination of both.

The terminal 400 may be used to acquire a clustering performance evaluation request, and the clustering performance evaluation request carries a plurality of first sample data, and a plurality of first clusters obtained by performing a clustering operation on the plurality of sample data.

In some embodiments, a clustering performance evaluation plug-in may be implanted in a client running in the terminal 400 to perform the method for cluster evaluation locally at the client. For example, the terminal 400 calls the clustering performance evaluation plug-in to perform the method for cluster evaluation, which includes: performing a clustering operation on a plurality of sample data to obtain a plurality of first clusters; for each first sample data from the plurality of the sample data, determining second sample data whose similarity with the first sample data is greater than a first threshold value from the plurality of the sample data; determining a confidence of the clustering operation corresponding to each first sample data based on a distribution of the second sample data in each of the first clusters; and evaluating the clustering operation based on the confidence corresponding to each first sample data to obtain an evaluation value.

In some embodiments, after obtaining the clustering performance evaluation request, the terminal 400 calls a clustering performance evaluation interface (which may be provided in a form of cloud service, that is, a service for cluster evaluation) of the server 200, the server 200 performs the method for cluster evaluation through the clustering performance evaluation plug-in, which includes: parsing the clustering performance evaluation request to obtain a plurality of sample data; performing a clustering operation on the plurality of sample data to obtain a plurality of first clusters; for each first sample data from the plurality of the sample data, determining second sample data whose similarity with the first sample data is greater than a first threshold value from the plurality of the sample data; determining a confidence of the clustering operation corresponding to each first sample data based on a distribution of the second sample data in each of the first clusters; and evaluating the clustering operation based on the confidence corresponding to each first sample data to obtain an evaluation value. The server 200 then returns the evaluation value to the terminal 400.

The method for cluster evaluation according to the embodiments of the present disclosure can be applied to various application scenarios. For example, in an application scenario of intelligent user marketing based on a large model, a high-quality script library can be constructed by the method for cluster evaluation according to the embodiments of the present disclosure, which will be described in detail below.

In an implementation scenario, an intelligent user marketing system performs a clustering operation on a script data set (i.e., the plurality of first sample data) to obtain a plurality of script clusters (i.e., the plurality of first clusters), and the terminal 400 receives a clustering performance evaluation request initiated by the intelligent user marketing system, immediately calls the clustering performance evaluation interface of the server 200, and sends the clustering performance evaluation request to the server 200; after receiving the request, the server 200 analyzes the clustering performance evaluation request to extract the script data set and the plurality of script clusters, then the server 200 evaluates the clustering operation to obtain an evaluation value, and returns the evaluation value to the terminal 400; and the terminal 400 further optimizes a classification strategy of script libraries, so as to improve dialog quality and effect of the intelligent user marketing system.

In an implementation scenario, the intelligent user marketing system performs a clustering operation on a user behavior data set (i.e., the plurality of first sample data) to obtain a plurality of user clusters (i.e., the plurality of first clusters), the terminal 400 receives a clustering performance evaluation request initiated by the intelligent user marketing system, immediately calls the clustering performance evaluation interface of the server 200, and sends the clustering performance evaluation request to the server 200; after receiving the request, the server 200 analyzes the clustering performance evaluation request to extract the user behavior data set and the plurality of user clusters, then the server 200 evaluates the clustering operation to obtain an evaluation value, and returns the evaluation value to the terminal 400; and the terminal 400 further optimizes a grouping strategy of the users, so as to improve the marketing effect.

In some embodiments, the server 200 may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, Content Delivery Networks (CDNs), and big data and artificial intelligence platforms.

The terminal 400 may be a smart phone, a tablet computer, a laptop, a desktop computer, a smart speaker, a smart watch, an intelligent voice interaction device, a smart home appliance, an in-vehicle terminal, an aircraft, or the like, but is not limited thereto. The terminal and the server may be directly or indirectly connected by wired or wireless communication, which is not limited in the embodiments of the present disclosure.

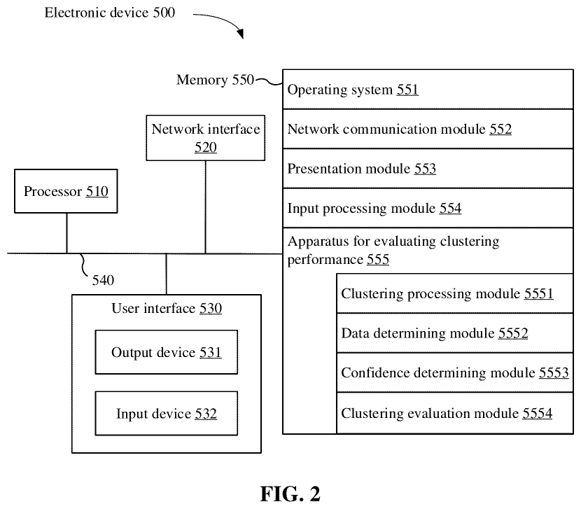

With reference to FIG. 2, FIG. 2 is a schematic structural diagram of an electronic device for cluster evaluation according to an embodiment of the present disclosure, and the electronic device 500 shown in FIG. 2 may be a terminal 400 or a server 200 in FIG. 1, and the electronic device 500 includes at least one processor 510, a memory 550, and at least one network interface 520. The various components in the server 200 are coupled together by a bus system 540. It will be appreciated that the bus system 540 is used to implement connection and communication between these components. The bus system 540 includes a power bus, a control bus, and a status signal bus, in addition to a data bus. However, for clarity of illustration, various buses are designated as the bus system 540 in FIG. 2.

The processor 510 may be an integrated circuit chip having signal processing capabilities, such as a general-purpose processor, a Digital Signal Processor (DSP), or any other programmable logic device, a discrete gate or transistor logic device, a discrete hardware component, or the like. Herein, the general-purpose processor may be a microprocessor, any conventional processor or the like.

The user interface 530 includes one or more output devices 531 that implement presentation of media contents, including one or more speakers and/or one or more visual display screens. The user interface 530 further includes one or more input devices 532, including user interface components that facilitate user input, such as a keyboard, a mouse, a microphone, a touch screen display, a camera, other input buttons and controls.

In some embodiments, when the terminal 400 independently performs the task of evaluating the clustering performance in the embodiment, the server 200 according to the embodiment of the present disclosure does not include the user interface 530.

The memory 550 may be removable, non-removable, or a combination thereof, exemplary hardware devices include solid state memories, hard disk drives, optical disk drives, etc., and the memory 550 optionally includes one or more storage devices physically located remotely from the processor 510.

The memory 550 includes a volatile memory or a non-volatile memory, and may include both volatile memory and non-volatile memory. The non-volatile memory may be a Read Only Memory (ROM), and the volatile memory may be a Random Access Memory (RAM). The memory 550 described in the embodiments of the present disclosure is intended to include any suitable type of memory.

In some embodiments, the memory 550 is capable of storing data to support various operations, and examples of the data include programs, modules, and data structures, or subsets or supersets thereof. Exemplarily, an operating system 551, a network communication module 552, a presentation module 553, an input processing module 554 are included, as described below.

The operating system 551 includes system programs for processing various basic system services and performing hardware-related tasks, such as a framework layer, a core library layer, a driver layer, etc., which are used for implementing various basic services and processing hardware-based tasks.

The network communication module 552 is configured to reach other computing devices via one or more (wired or wireless) network interfaces 520. The exemplary network interfaces 520 include: Bluetooth, Wireless Compatibility Authentication (WiFi), and Universal Serial Bus (USB), etc.

A presentation module 553 is configured to enable information to be presented via one or more output devices 531 (e.g., a display screen, speakers, etc.) associated with the user interface 530 (e.g., a user interface for operating peripherals and displaying content and information)

In some embodiments, when the terminal 400 independently performs the task of cluster evaluation, the server 200 according to the embodiment of the present disclosure may not include the presentation module 553.

The input processing module 554 is configured to detect one or more user inputs or interactions from one of one or more input devices 532 and translate the detected inputs or interactions. In some embodiments, when the terminal 400 independently performs the task of cluster evaluation in the embodiment, the server 200 according to the embodiment of the present disclosure may not include the presentation module 553.

In some embodiments, the apparatus according to the embodiments of the present disclosure may be implemented by software. FIG. 2 shows an apparatus 555 for cluster evaluation stored in the memory 550, which may be software in the form of programs and plug-ins, and includes the following software modules: a clustering processing module 5551, a data determining module 5552, a confidence determining module 5553, and a clustering evaluation module 5554. These modules are logical and can be arbitrarily combined or further split according to the implemented functions. The functions of the respective modules will be described below.

In other embodiments, the apparatus according to the embodiment of the present disclosure may be implemented in a hardware manner. As an example, the apparatus according to the embodiment of the present disclosure may be a processor in the form of a hardware decoding processor programmed to perform the method for cluster evaluation according to the embodiment of the present disclosure. For example, the processor in the form of the hardware decoding processor may adopt one or more Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), or other electronic components.

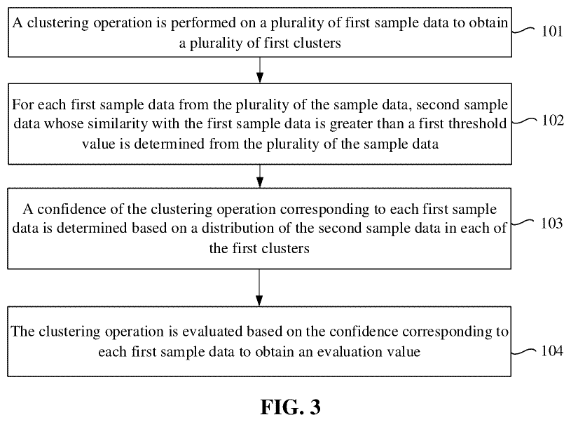

As described above, since the electronic device that performs the method for cluster evaluation according to the embodiments of the present disclosure may be a terminal, a server, or a combination of both, the execution body of each operation will not be repeatedly described hereinafter. With reference to FIG. 3, it is a first schematic flowchart of the method for cluster evaluation according to an embodiment of the present disclosure, and will be described in conjunction with the operations shown in FIG. 3.

In operation 101, a clustering operation is performed on a plurality of sample data to obtain a plurality of first clusters.

As an example, a plurality of seed point sample data are selected from a plurality of sample data included in a sample data set, and a clustering operation is performed on the plurality of sample data using the seed point sample data as cluster centers to obtain the plurality of first clusters, herein the seed point sample data are in one-to-one correspondence with the cluster centers, the seed point sample data are in one-to-one correspondence with the first clusters, and each first cluster includes at least one first sample data.

The clustering operation may be performed on the plurality of sample data based on a K-Means clustering algorithm (K-Means algorithm), or based on any other clustering algorithm, which is not limited herein. The selection of the plurality of seed point sample data from the plurality of sample data may be random selection, or may be selection based on a density peak algorithm, a farthest point sampling algorithm or the like, which is not limited herein.

For example, the sample data set may include N first sample data that may be expressed as {t₁ . . . tᵢ . . . t_{N}}, where N is a positive integer greater than 1, tᵢ is the i-th first sample data among the N first sample data, and i is a positive integer that increases sequentially and i≤N.

k seed point sample data are selected from the N first sample data, the k seed point sample data are taken as cluster centers to perform the clustering operation on the N first sample data to obtain k first clusters, and the k first clusters can be expressed as {C₁ . . . Cⱼ . . . Cₖ}, where k is a positive integer, Cⱼ is the j-th first cluster among the k first clusters, and j is a positive integer that increases sequentially and j≤k.

In the embodiment of the present disclosure, by selecting a plurality of seed point sample data from a plurality of sample data as the cluster centers to perform the clustering operation, the efficiency and accuracy of clustering can be effectively improved.

In operation 102, for each first sample data from the plurality of the sample data, second sample data whose similarity with the first sample data is greater than a first threshold value is determined from the plurality of the sample data.

The first threshold value includes a similarity threshold value and a preset number, and the first threshold value may be a threshold value set based on engineering experiences, or a threshold value predicted based on a corresponding neural network model, which is not limited herein.

As an example, for each first sample data from the plurality of the sample data, the following processing is performed: determining similarities between the first sample data and the remaining first sample data in the sample data set, and determining a preset number of first sample data having the highest similarity with the first sample data as the second sample data, or determining first sample data whose similarity with the first sample data greater than a similarity threshold as the second sample data.

By performing the above processing for each first sample data from the plurality of the sample data, second sample data corresponding to each first sample data is determined from the plurality of sample data.

Following the above example, when the first threshold value is a preset number, the preset number may be expressed as K, for the i-th first sample data tᵢ among the N first sample data {t₁ . . . tᵢ . . . t_{N}}, K first sample data having the highest similarity with the first sample data t; are determined from the N first sample data {t₁ . . . tᵢ . . . t_{N}}, and the K first sample data are determined as the second sample data corresponding to the first sample data tᵢ, where K is a positive integer.

In some embodiments, the methods of “determining the similarity between the first sample data and the remaining first sample data in the sample data set” are different based on the different data types of the plurality of first sample data, and the data types of the plurality of first sample data include a numerical type, a text type, an image type, etc. When the data type of the plurality of first sample data is the numerical type, the similarity between the first sample data may be determined by the Euclidean distance, Manhattan distance, cosine distance or the like; when the data type of the plurality of first sample data is the text type, the similarity between the first sample data may be determined by the Term Frequency-Inverse Document Frequency (TF-IDF), an editing distance (for example, Levenshtein distance) or the like; when the data type of the plurality of first sample data is the image type, the similarity between the first sample data may be determined by a Structural Similarity (SSIM) index, or the similarity between the first sample data may be determined based on the similarity between coded features of the first sample data after the coded features of the first sample data are extracted by a neural network model (e.g., a convolutional neural network model).

In the embodiment of the present disclosure, by determining the second sample data whose similarity is greater than the first threshold value for each first sample data from the plurality of the sample data, a data subset (i.e., a set of the second sample data) highly correlated with each first sample data can be effectively extracted, and a solid data foundation can be provided for subsequent clustering performance evaluation. In addition, the corresponding similarity determination methods are adopted depending on the different data types of the plurality of first sample data, which ensures the scientificity and adaptability of similarity evaluation, and enables the method for cluster evaluation according to the embodiment of the present disclosure to be widely applied to a variety of data types and application scenarios.

In operation 103, a confidence of the clustering operation corresponding to each first sample data is determined based on a distribution of the second sample data in each of the first clusters.

In some embodiments, when the distribution of the second sample data in each of the first clusters is the quantitative distribution of the second sample data in each of the first clusters, “determining a confidence of the clustering operation corresponding to each first sample data based on a distribution of the second sample data in each of the first clusters” in operation 103 shown in FIG. 3 may be implemented by performing the following processing: determining, based on the distribution, a fourth number of second sample data included in each of the first clusters; determining a ratio of the fourth number to a fifth number of sample data included in each of the first clusters as a correlation degree between each first sample data and each of the first clusters; and determining, based on correlation degrees corresponding to each first sample data, the confidence of the clustering operation corresponding to each first sample data.

Herein, the correlation degree is a degree of association between the first sample data and the first cluster, and the degree of association may be represented by a probability that the first sample data belongs to the first cluster, may be represented by a distance between the first sample data and the seed point sample data of the first cluster, or may be represented by an average value of distances between the first sample data and all sample data in the first cluster, which is not limited herein.

As an example, for each first sample data from the plurality of the sample data, the following processing is performed: determining a correlation degree between the first sample data and each first cluster based on a distribution of the second sample data corresponding to the first sample data in each first cluster, herein the distribution of the second sample data corresponding to the first sample data in each first cluster includes a quantitative distribution of the second sample data in each first cluster and/or a spatial distribution of the second sample data in each first cluster.

The above processing is performed for each first sample data from the plurality of the sample data to determine a correlation degree between each first sample data and each first cluster. For example, the clustering operation is performed on sample data 1, sample data 2 and sample data 3 (i.e., the plurality of first sample data) to obtain a cluster 1 and a cluster 2 (i.e., the plurality of first clusters), and the correlation degrees between the sample data 1 and the cluster 1 as well as the cluster 2 are determined respectively based on the distributions of the second sample data corresponding to the sample data 1 in the cluster 1 and the cluster 2 to obtain the correlation degree P_{1,1} between the sample data 1 and the cluster 1, the correlation degree P_{1,2} between the sample data 1 and the cluster 2, and so on. The correlation degrees between all first sample data and all clusters include: correlation degree P_{1,1}, correlation degree P_{1,2}, correlation degree P_{2,1}, correlation degree P_{2,2}, correlation degree P_{3,1} and correlation degree P_{3,2}.

Herein, the quantitative distribution of the second sample data in each of the first clusters is a number of second sample data included in each of the first clusters.

As an example, for each of the plurality of first clusters, the following processing is performed: determining, based on the quantitative distribution, the fourth number of second sample data included in the first cluster; determining a ratio of the fourth number to a fifth number of sample data included in the first cluster as the correlation degree between each first sample data and the first cluster; and determining, based on correlation degrees corresponding to each first sample data, the confidence of the clustering operation corresponding to each first sample data.

The above processing is performed for each of the plurality of first clusters to determine the correlation degree between each first sample data and each of the first clusters.

Following the above example, K second sample data corresponding to the first sample data tᵢ of the N first sample data {t₁ . . . tᵢ . . . t_{N}} are determined, the fourth number of the second sample data included in the j-th first cluster Cⱼ is determined based on the quantitative distributions of the K second sample data in each first cluster, and the fourth number may be expressed as t_{i,j}; and the fifth number of sample data included in the first cluster Cⱼ is determined, and the fifth number may be expressed as cⱼ; and a ratio

$$\frac{{t}_{i , j}}{{c}_{j}}$$

between the fourth number and the fifth number is determined as a correlation degree between the first sample data tᵢ and the first cluster Cⱼ, and the correlation degree may be expressed as p(cⱼ|t_{i,j}).

In the embodiment of the present disclosure, the correlation degree between each first sample data and each cluster is determined by the ratio of the fourth number of second sample data included in each cluster to the fifth number of sample data included in each cluster, which can not only clearly reflect the strength (i.e. correlation degree) between each first sample data and each cluster, but also provide reliable data support for subsequent evaluation of clustering performance and decision-making of clustering results. In addition, this calculation method based on quantitative distribution is simple and efficient, and easy to implement and optimize.

In some embodiments, when the distribution of the second sample data in each of the first clusters is the spatial distribution of the second sample data in each of the first clusters, the “determining a confidence of the clustering operation corresponding to each first sample data based on a distribution of the second sample data in each of the first clusters” in operation 103 shown in FIG. 3 may be implemented by performing the following processing: for each of the first clusters, determining a first average similarity between sample data included in the first cluster, and determining, based on the distribution, a second average similarity between the second sample data included in the first cluster and seed point sample data of the first cluster; determining a ratio of the second average similarity to the first average similarity as the correlation degree between each first sample data and each of the first clusters; and determining, based on correlation degrees corresponding to each first sample data, the confidence of the clustering operation corresponding to each first sample data.

The spatial distribution of the second sample data in each of the first clusters includes a distance between the second sample data and the seed point sample data of each of the first clusters. For the manner for determining the distance between the second sample data and the seed point sample data, reference can be made to the manner for determining the similarity between the sample data shown in operation 102 above, which is not repeated herein.

As an example, for each of the plurality of first clusters, the following processing is performed: determining similarities between every two sample data in the first cluster and determining an average value of the similarities between every two sample data in the first cluster as the first average similarity; determining similarities between respective second sample data included in the first cluster and the seed point sample data of the first cluster based on the spatial distribution, and determining an average value of the similarities between the second sample data and the seed point sample data of the first cluster as a second average similarity; determining a ratio of the second average similarity to the first average similarity as a correlation degree between each first sample data and the first cluster; and determining, based on correlation degrees corresponding to each first sample data, the confidence of the clustering operation corresponding to each first sample data.

The above processing is performed for each of the plurality of first clusters to determine the correlation degree between each first sample data and each of the first clusters.

In the embodiment of the present disclosure, the spatial distribution of the second sample data in the cluster can be more accurately measured by the first average similarity between the sample data in each first cluster and the second average similarity between the second sample data and the seed point sample data of the first cluster; and by taking the ratio of the second average similarity to the first average similarity as the correlation degree, misjudgment caused by the difference cluster sizes can be avoided, and the correlation degree between each first sample data and each first cluster can be effectively reflected.

After the correlation degree between each first sample data and each of the first clusters is determined, the following processing is performed for each first sample data from the plurality of the sample data: a greatest correlation degree among the plurality of correlation degrees between the first sample data and the plurality of first clusters may be determined as the confidence of performing the clustering operation for the first sample data (i.e., the confidence corresponding to the first sample); an average value of the plurality of correlation degrees between the first sample data and the plurality of first clusters may be determined as the confidence corresponding to the first sample; a conditional entropy (uncertainty) of the clustering operation performed for the first sample data may be determined by a conditional entropy determination formula (1.1) based on the plurality of correlation degrees between the first sample data and the plurality of first clusters, where the conditional entropy may be expressed as H, and the confidence corresponding to the first sample is determined based on the conditional entropy. The conditional entropy is negatively correlated with the confidence corresponding to the first sample, and the confidence may be expressed as −H. The formula (1.1) is as follows.

$$H = - {Σ}_{j = 1}^{k} p ( {c}_{j} \vert {t}_{i , j} ) ln p ( {c}_{j} \vert {t}_{i , j} ) \qquad ( 1.1 )$$

Herein, H is the conditional entropy, p(cⱼ|t_{i,j}) is a correlation degree between the i-th first sample data among the N first sample data and the j-th first cluster, cⱼ is a fifth number of sample data included in the j-th first cluster, t_{i,j} is a fourth number of second sample data included in the j-th first cluster, and k is a number of the first clusters.

In the embodiment of the present disclosure, the confidence corresponding to the first sample can be determined by various manner, and these diversified evaluation manners improve the adaptability and reliability of the method for cluster evaluation according to the embodiment of the present disclosure, so that it can better meet the needs in different scenarios.

In operation 104, the clustering operation is evaluated based on the confidence corresponding to each first sample data to obtain an evaluation value.

As an example, a plurality of confidences of clustering results of a plurality of first sample data are obtained by calculating a confidence corresponding to each first sample data, and a weighted average processing is performed on the plurality of confidences based on a weight coefficient of each first sample data to obtain an evaluation value. The evaluation value is an index for evaluating the performance of the clustering operation, and the evaluation value is positively correlated with the performance of the clustering operation. That is to say, the higher the evaluation value is, the better the performance of the clustering operation is.

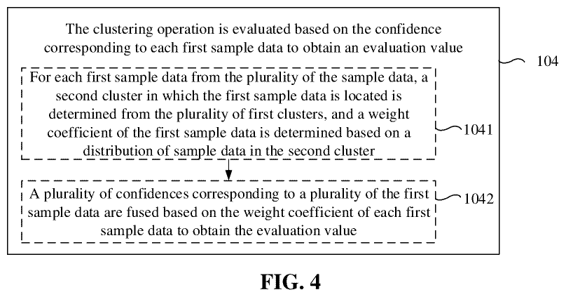

In some embodiments, with reference to FIG. 4, it is a second schematic flowchart of the method for cluster evaluation according to an embodiment of the present disclosure, and operation 104 shown in FIG. 3 can be implemented by the following operations 1041 to 1042, which will be described in detail below.

In operation 1041, for each first sample data from the plurality of the sample data, a second cluster in which the first sample data is located is determined from the plurality of first clusters, and a weight coefficient of the first sample data is determined based on a distribution of sample data in the second cluster.

As an example, for each first sample data from the plurality of the sample data, a following process is performed: determining the weight coefficient of the first sample data based on distributions of all sample data in the second cluster in which the first sample data is located. The above processing is performed for each first sample data from the plurality of the sample data, and the weight coefficient of each first sample data is determined.

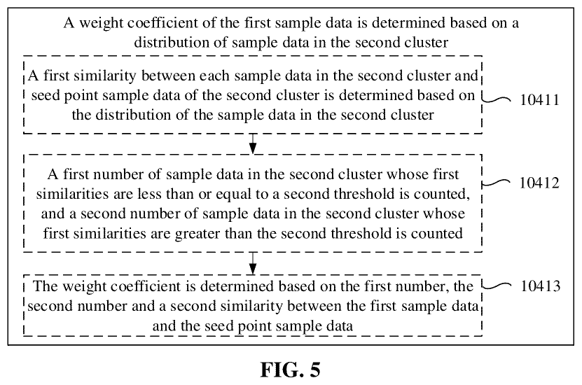

In some embodiments, with reference to FIG. 5, FIG. 5 is a third flowchart of the method for cluster evaluation according to an embodiment of the present disclosure, and “a weight coefficient of the first sample data is determined based on a distribution of sample data in the second cluster” in operation 1041 shown in FIG. 5 can be implemented by the following operations 10411 to 10413, which will be described in detail below.

In operation 10411, a first similarity between each sample data in the second cluster and seed point sample data of the second cluster is determined based on the distribution of the sample data in the second cluster.

The distribution of the sample data in the second cluster includes a distance between each sample data in the second cluster and the seed point sample data of the second cluster. For the manner for determining the distance between each sample data in the second cluster and the seed point sample data of the second cluster, reference can be made to the manner for determining the similarity between the first sample data shown in operation 102 above, which is not repeated herein.

As an example, a distance between each sample data in the second cluster and the seed point sample data of the second cluster included in the distribution of sample data in the second cluster is determined as the first similarity between each sample data in the second cluster and the seed point sample data of the second cluster.

In operation 10412, a first number of sample data in the second cluster whose first similarities are less than or equal to a second threshold is counted, and a second number of sample data in the second cluster whose first similarities are greater than the second threshold is counted.

The sample data in the second cluster whose first similarity is less than or equal to the second threshold value is the core sample data in the second cluster, the core sample data is the sample data highly similar to the seed point sample data of the second cluster and can represent the characteristics of the second cluster; and the sample data in the second cluster whose first similarity is greater than the second threshold value is the non-core sample data in the second cluster, the non-core sample data is the sample data at the edge of the second cluster and has large variability. The second threshold may be a threshold value set based on engineering experiences, an average value of the first similarities between all sample data in the second cluster and the seed point sample data of the second cluster, or a threshold value predicted based on a corresponding neural network model, which is not limited herein.

As an example, a first number of core sample data and a second number of non-core sample data in the second cluster are counted based on a first similarity between each sample data in the second cluster and the seed point sample data of the second cluster.

In operation 10413, the weight coefficient is determined based on the first number, the second number and a second similarity between the first sample data and the seed point sample data.

As an example, the second similarity between the first sample data and the seed point sample data is determined based on the distribution of the sample data in the second cluster, and the weight coefficient is determined based on the first number, the second number, and the second similarity.

In some embodiments, the operation 10413 shown in FIG. 5 may be implemented by: if the second similarity is less than or equal to the second threshold, determining a maximum number of the first number and the second number, and determining a ratio of the maximum number to a third number of sample data included in the second cluster as the weight coefficient; if the second similarity is greater than the second threshold, determining a minimum number of the first number and the second number, and determining a ratio of the minimum number to the third number as the weight coefficient.

As an example, a third number of sample data included in the second cluster is determined, and a maximum number and a minimum number among a first number of core sample data in the second cluster and a second number of non-core sample data in the second cluster are determined. For example, when the first number of core sample data in the second cluster is larger than the second number of non-core sample data, the maximum number is the first number, the minimum number is the second number, and vice versa.

If the second similarity between the first sample data and the seed point sample data is less than or equal to the second threshold, it represents that that the first sample data is the core sample data in the second cluster, and the ratio of the maximum number to the third number is determined as the weight coefficient by formula (1.2), which is as follows.

$$l ( {t}_{i} ) = α = \frac{max ( f i r s t n u m b e Γ , s e c o n d n u m b e r )}{t h {i}_{Γ} d n u m b e Γ}$$

Herein, I(tᵢ) is a weight coefficient of the first sample data tᵢ, tᵢ is an i-th first sample data among the N first sample data, and max (first number, second number) is a maximum number, and a is a ratio of the maximum number to the third number.

If the second similarity between the first sample data and the seed point sample data is greater than the second threshold, it represents that that the first sample data is non-core sample data in the second cluster, and the ratio of the minimum number to the third number is determined as the weight coefficient by formula (1.3), which is as follows.

$$I ( {t}_{i} ) = 1 - α = \frac{third number - max ( first number , second number )}{third number} = \frac{min ( first number , second number )}{third number} \qquad ( 1.3 )$$

Herein, I(tᵢ) is a weight coefficient of the first sample data tᵢ, tᵢ is an i-th first sample data among the N first sample data, and min (first number, second number) is a minimum number, and a is a ratio of the maximum number to the third number.

In the embodiment of the present disclosure, the core sample data and the non-core sample data in the second cluster are distinguished by comparing the magnitude relationship between the first similarity between each sample data and the seed point sample data and the second threshold value. Furthermore, the weight coefficient of the first sample data is dynamically adjusted according to the second similarity between the first sample data and the seed point sample data as well as the ratio of the number of core sample data to the number of non-core sample data, so that the weight coefficient of the first sample data can better reflect the importance and representativeness of the first sample data in the second cluster.

In operation 1042, a plurality of confidences corresponding to a plurality of the first sample data are fused based on the weight coefficient of each first sample data to obtain the evaluation value.

As an example, based on the weight coefficient of each first sample data, a weighted average processing is performed on the plurality of confidences corresponding to the plurality of first sample data to obtain an evaluation value for evaluating the performance of the clustering operation.

In a case where a greatest correlation degree among the plurality of correlation degrees between the first sample data and the plurality of first clusters is determined as the confidence corresponding to the first sample data, the evaluation value may be determined by the formula (1.4), which is as follows.

$$X = \frac{{Σ}_{i = 1}^{N} I ( {t}_{i} ) max ( p ( {c}_{j} \vert {t}_{i , j} ) )}{N} \qquad ( 1.4 )$$

Herein, X is the evaluation value, I(tᵢ) is the weight coefficient of the first sample data tᵢ, tᵢ is an i-th first sample data among the N first sample data, N is the number of first sample data, max (p(cⱼ|t_{i,j})) is the confidence corresponding to the first sample data tᵢ (i.e., the largest correlation degree among the plurality of correlation degrees between the first sample data tᵢ and the plurality of first clusters), p(cⱼ|t_{i,j}) is the correlation degree between the first sample data tᵢ and a j-th first cluster, cⱼ is the fifth number of sample data included in the j-th first cluster, and t_{i,j} is the fourth number of second sample data included in the j-th first cluster.

In a case where the confidence corresponding to the first sample data is determined based on the corresponding conditional entropy of the first sample data, an uncertainty score of the clustering operation can be determined by formula (1.5), and the evaluation value can be determined based on the uncertainty score of the clustering operation. The evaluation value is negatively correlated with the uncertainty score of the clustering operation. The formula (1.5) is as follows.

$$S = \frac{{Σ}_{i = 1}^{N} I ( {t}_{i} ) ( - {Σ}_{j = 1}^{k} p ( {c}_{j} \vert {t}_{i , j} ) ln p ( {c}_{j} \vert {t}_{i , j} ) )}{N} = - \frac{1}{N} {Σ}_{i = 1}^{N} {Σ}_{j = 1}^{k} I ( {t}_{i} ) * p ( {c}_{j} \vert {t}_{i , j} ) ln p ( {c}_{j} \vert {t}_{i , j} ) \qquad ( 1.5 )$$

Herein, S is an uncertainty score of the clustering operation, I(tᵢ) is a weight coefficient of the first sample data tᵢ, tᵢ is an i-th first sample data among the N first sample data, N is the number of first ample data,

$$- {Σ}_{j = 1}^{k} p ( {c}_{j} \vert {t}_{i , j} ) ln p ( {c}_{j} \vert {t}_{i , j} )$$

is a conditional entropy of a clustering result of the first sample data tᵢ, p(cⱼ|t_{i,j}) is a correlation degree between the first sample data tᵢ and the j-th first cluster, cⱼ is the fifth number of sample data included in the j-th first cluster, t_{i,j} is the fourth number of second sample data included in the j-th first cluster, and k is the number of the first clusters.

In the embodiment of the present disclosure, the weighting coefficient is introduced to perform weighted average processing on the confidences corresponding to each first sample data to obtain the evaluation value, and the evaluation value can more accurately reflect the overall quality of the clustering result, and the positive correlation between the evaluation value and the clustering performance provides a clear index for quantitative evaluation of the clustering effect, thereby providing a powerful basis for optimizing an clustering algorithm and adjusting parameters.

In some embodiments, after operation 104 shown in FIG. 3, the following processing may be performed: determining a greatest evaluation value from the evaluation values obtained by evaluating a plurality of clustering operations respectively; and determining a plurality of clusters obtained by the clustering operation corresponding to the greatest evaluation value as a clustering result of the plurality of the sample data.

As an example, a plurality of clustering operations are performed on the plurality of sample data based on different seed point sample data sets, and the plurality of clustering operations are evaluated respectively to obtain a plurality of evaluation values corresponding to the plurality of clustering operations respectively, a greatest evaluation value is determined from the plurality of evaluation values; and a plurality of clusters obtained by the clustering operation corresponding to the greatest evaluation value are determined as the clustering result of the plurality of the sample data.

In the embodiment of the present disclosure, the plurality of sample data are clustered multiple times through different seed point sample data sets, and an evaluation value for measuring the performance of the clustering operation is obtained when each clustering operation is performed. By comparing these evaluation values, the clustering result corresponding to the greatest evaluation value is selected, the deviation of the clustering result caused by the randomness of selected seed point(s) can be effectively avoided, thus it is ensured that the finally selected clustering result has the highest quality and optimal performance, and the accuracy and consistency of the clustering result can be improved.

Hereinafter, an exemplary application of the method for cluster evaluation according to the embodiment of the present disclosure in an intelligent user marketing application scenario based on a large model will be described.

The clustering belongs to unsupervised classification method, which refers to dividing the sample data set into different clusters according to some specific rules, so that the similarity of sample data a same cluster is as large as possible, and the similarity of sample data between different clusters is as small as possible. At the data level, the possibility that sample data with similar eigenvalues is aggregated is high, and the possibility that sample data with different eigenvalues is aggregated is small. At the formal level, the closer the sample data in the same cluster and the farther the distances between clusters, the better the clustering effect, i.e., the better the performance of unsupervised classification.

Clustering algorithms can be applied to various fields, which usually require finding natural associations in a sample data set. Depending on different fields and specific applications, clustering algorithms also have various application forms. For example, in business, the clustering algorithm can help market analysts discover different customer groups from the basic customer database, and use purchase patterns to characterize different customer groups. In biology, the clustering algorithm can be used to deduce the classification of plants and animals, classify genes, and gain an understanding of the inherent structure of populations. In terms of geographic information, the clustering algorithm can play a role in the determination of similar areas in an earth observation database, the grouping of car insurance policy holders, and the grouping of houses in a city according to type, value and geographical location of houses. The clustering can also be used to classify documents. In addition, the clustering algorithm can be used as a preprocessing operation of other data mining algorithms, so that the data mining algorithm can perform secondary analysis based on clusters obtained by the clustering algorithm.

Whether the clustering results are directly applied or the secondary analysis is carried out based on the clustering results, the quality of the clustering results play a decisive role in the practical application effect. Therefore, it is necessary to evaluate the clustering results to analyze the quality of the clustering results.

The evaluation metrics of clustering performance can be divided into two categories according to whether the sample data contains labeled data. One evaluation metrics lies in the comparison of the clustering results with labeled data, which is called external metrics; and the other evaluation metrics lies in direct analysis of the clustering results, which is called internal metrics. Commonly used external metrics includes RI, adjusted RI, adjusted mutual information index, etc. The disadvantage of methods involving such metrics is that they need to clarify the labeling information of sample data, thus these methods are difficult to be applied in practice. Commonly used internal metrics include silhouette coefficient, variance ratio criterion, Davies-Bouldin index, etc. Methods involving such metrics focus on the global structure of clustering results and ignore local details (that is to say, they only pay attention to compactness of a cluster and a separation degree between clusters), and then evaluate the performance of clustering processing by the performance of clusters. These methods cannot capture the influence of each sample data on the whole clustering results and are sensitive to noise and outliers, thus affecting the accuracy of clustering performance evaluation.

In intelligent user marketing application scenarios based on a large model (i.e. large telemarketing model), since the large model is a generative model, its generative scripts are not completely controllable, and for individual large model structures that are data-driven, Supervised Fine-Tuning (SFT, Supervised Fine-Tuning) of the large model is required when data is added. In the process of SFT of the large model, problems such as the loss of general capabilities of the large model, catastrophic forgetting of knowledge, and mixed ratios of training data will occur. In order to solve the above problems, a high-quality script library can be built, and with the help of the powerful retrieval and matching capabilities of the large model, relevant contents can be accurately extracted from the script library, thereby generating higher-quality script text that meets the needs.

In the process of constructing a high-quality script library, the text under each general script label in the historical man-made call data can be automatically extracted through the large model. Since there may be a variety of script labels under each script label, in order to enable a script output by the model to accurately match the best script in the script library, it is necessary to construct a more detailed secondary script label for each general script label.

In the process of constructing a more detailed secondary script label, it is necessary to separately cluster texts under each script label, specifically, automatically extract the texts under any script label, and determine the texts under any script label as a sample data set (i.e., the plurality of first sample data above). Then, K sample data (i.e., the above second sample data) closest to each sample data (i.e., the above first sample data) are obtained by distance calculation or similarity calculation. Then, clustering processing is performed on the sample data set, and after the clustering processing is completed, a classification certainty value (i.e., the above correlation degree) is determined for each sample data, that is, the ratio of the number of K sample data closest to the sample data included in a certain cluster to the total number of sample data of the cluster. Then, it is determined, based on a determination condition for core sample data in the cluster, whether the sample data is the core sample data in the cluster in which it is located, and then the certainty measure value of the sample data classification is determined based on in combination with the adaptive weight coefficient of the sample data. Finally, an average value of the certainty measure values of all sample data is obtained, and the average value of the certainty measure values of all sample data is determined as a clustering performance measure value S (i.e., the uncertainty score of the clustering operation above). The smaller the clustering performance measure value S, the higher the clustering performance. By repeating performing clustering for many times, a clustering result with highest clustering performance is determined based on the clustering performance measure values S, and output as a final clustering result.

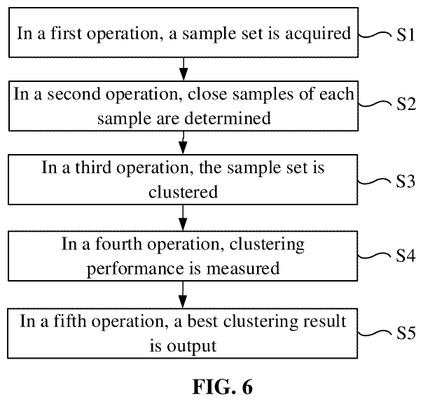

With reference to FIG. 6, FIG. 6 is a fourth schematic flowchart of the method for cluster evaluation according to an embodiment of the present disclosure, the method for cluster evaluation according to the embodiment of the present disclosure will be described below based on first to fifth operations shown in FIG. 6.

In a first operation S1, a sample set is acquired.

A sample set (i.e., the plurality of first sample data above) is obtained, the sample set containing N samples (i.e., first sample data above), which are t₁, t₂, . . . , t_{N} respectively, where N is a positive integer greater than 1.

In a second operation S2, close samples (i.e., the second sample data above) of each sample are determined.

In the sample set, K closest samples of each sample are obtained by distance calculation or similarity calculation, where K is a positive integer. Herein, the Euclidean distance, cosine similarity or the like can be adopted to implement the distance calculation or similarity calculation, and the value range of K can be

$$\frac{N}{10 k} < K < \frac{N}{5 k} ,$$

where k is the number of clusters obtained after clustering. If the value of K is too large, the overall calculation rate will be reduced, and if the value of K is too small, the noise data will affect the accuracy of the measurement method.

In a third operation S3, the sample set is clustered.

Clustering processing is performed on the N samples to obtain k clusters (i.e., the clusters above), which are C₁, C₂, . . . , Cₖ respectively, the number of samples corresponding to each cluster is c₁, c₂, . . . , cₖ, and t_{i,j} represents a number (i.e., the fourth number above) of samples contained in the cluster Cⱼ among K samples closest to the sample tᵢ, then the number of samples contained in each cluster among the K samples closest to each sample can be shown in Table 1 below.

TABLE 1

| | | | | | Is it a core |
|---|---|---|---|---|---|
| | Cluster | Cluster | | Cluster | sample within |
| Number | C₁ | C₂ | . . . | Cₖ | the cluster |
| Sample t₁ | t_{1, 1} | t_{1, 2} | . . . | t_{1, k} | 1 |
| Sample t₂ | t_{2, 1} | t_{2, 2} | . . . | t_{2, k} | 0 |
| . . . | . . . | . . . | . . . | | 0 |
| Sample t_{N} | t_{N, 1} | t_{N, 2} | . . . | t_{N, k} | 1 |

Herein, t_{i,1}+t_{i,2}+ . . . +t_{i,k}=K, where i is a positive integer that increases sequentially, and 1≤i≤N.

In the column “Is it a core sample in the cluster” in Table 1, 1 represents that the corresponding sample is a core sample in the cluster, and 0 represents that the corresponding sample is not a core sample in the cluster. Whether it is a core sample in the cluster is determined as follows. If the distance between the sample and the seed point (i.e. the above seed point sample data) is less than or equal to an average value of distances between all samples in the cluster and the seed point, the sample is a core sample (i.e. the above core sample data) in the cluster; otherwise the sample is not the core sample (i.e. the above non-core sample data) in the cluster. Clustering algorithms such as K-means can be used for clustering N samples, which is not limited here.

In a fourth operation S4, clustering performance is measured.

By formula (2.1), the clustering performance measure value S is determined, and formula (2.1) is as follows.

$$S = - \frac{1}{N} {Σ}_{i = 1}^{N} {Σ}_{j = 1}^{k} I ( {t}_{i} ) * p ( {c}_{j} \vert {t}_{i , j} ) ln p ( {c}_{j} \vert {t}_{i , j} ) \qquad ( 2.1 )$$

Herein, p(cⱼ|t_{i,j}) represents a ratio (i.e., the correlation degree above) of a number t_{i,j} of sample contained in the cluster Cⱼ among K samples closest to the sample tᵢ to the total number cⱼ of samples in the cluster Cⱼ, that is

$$p ( {c}_{j} \vert {t}_{i , j} ) = \frac{{t}_{i , j}}{{c}_{j}} ,$$

where I(tᵢ) is an indicator function (i.e., the weight coefficient above). Through formula (2.2), when the sample tᵢ is a core sample in the cluster C_{I}, I(tᵢ)=α; and when the sample tᵢ is not the core sample in the cluster C_{I}, I(tᵢ)=1−α, and formula (2.2) is as follows.

$$I ( {t}_{i} ) = \{ \begin{matrix}α ; {t}_{i} is core sample in cluster {C}_{I} \\ 1 - α ; {t}_{i} is not core sample in cluster {C}_{I}\end{matrix} , α = \frac{max ( number of core samples in cluster {C}_{I} , number of non - core samples in cluster {C}_{I} )}{( total number of samples in cluster {C}_{I} )} \qquad ( 2.2 )$$

In formula (2.2), the cluster C_{I} is the cluster where the sample tᵢ is located, α is the adaptive weight coefficient of the sample tᵢ, max (number of core samples in cluster Cⱼ, number of non-core sample in cluster C_{I}) represents the maximum value of the number of core samples in the cluster C; and the number of non-core samples in the cluster Cⱼ.

p(cⱼ|t_{i,j}) measures the probability that the sample tᵢ belongs to the cluster Cⱼ; and

$$- {Σ}_{j = 1}^{k} p ( {c}_{j} \vert {t}_{i , j} ) ln p ( {c}_{j} \vert {t}_{i , j} )$$

measures the certainty of classification of the sample tᵢ, the smaller the value, the higher the certainty of classification;

$$- {Σ}_{i = 1}^{N} {Σ}_{j = 1}^{k} p ( {c}_{j} \vert {t}_{i , j} ) ln p ( {c}_{j} \vert {t}_{i , j} )$$

measures the certainty of classification of all samples, the smaller the value, the higher the certainty of classification. If for any cluster, the certainty that each sample belongs to the cluster is high, it means that the cluster structure is clear; on the contrary, if there are many samples with low certainty, the value of

$$- {Σ}_{i = 1}^{N} {Σ}_{j = 1}^{k} p ( {c}_{j} \vert {t}_{i , j} ) ln p ( {c}_{j} \vert {t}_{i , j} )$$

will be large, thus reflecting poor clustering quality.

$$- \frac{1}{N} {Σ}_{i = 1}^{N} {Σ}_{j = 1}^{k} p ( {c}_{j} \vert {t}_{i , j} ) ln p ( {c}_{j} \vert {t}_{i , j} )$$

is an average value of certainty measures values of all samples, the smaller the value, the higher the clustering quality (because most samples and their respective K closest samples are concentrated in one or two clusters, instead of being scattered in multiple clusters). α is an adaptive weight coefficient, a weighting mechanism is introduced so that firstly, the core samples in the cluster contribute more to the overall certainty measures, and secondly, influences of noises and outliers on the measurement method are reduced (if there are noises and outliers, they generally appear in the edge area within the cluster, i.e., far away from the seed point, that is so say, in the non-core samples within the cluster).

In a fifth operation S5, a best clustering result is output.

The third operation and the fourth operation are repeated many times for N samples, and the clustering result with a smallest clustering performance measure value S is taken as a final clustering output.

There is no fixed seed point for each clustering, so the clustering result is different each time. In the embodiment of the present disclosure, the quality of the clustering performance is determined by comparing the clustering performance measure values S from multiple times of clustering, so as to select the best clustering result, and the clustering algorithm is not limited herein.

The beneficial effects of the method for cluster evaluation according to the embodiment of the present disclosure are as follows.
1) The method for cluster evaluation according to the embodiment of the present disclosure can implement the evaluation of clustering performance based on the influence of each sample on the entire clustering.
2) When measuring the certainty of sample classification, the method for cluster evaluation according to the embodiment of the present disclosure measures the compactness within the cluster and the separation degree between the clusters through p(cⱼ t_{i,j}), so as to implement the evaluation of clustering performance by taking into account the compactness within the cluster and the separation degree between the clusters.
3) The method for cluster evaluation according to the embodiment of the present disclosure introduces an adaptive weight coefficient, so that the core samples in the cluster can contribute more to the overall deterministic measure, and at the same time the influence of noise and outliers on the measurement method is reduced, thereby improving the accuracy of clustering performance measurement.

The following will continue to describe an exemplary structure of the clustering performance evaluation device 555 according to the embodiment of the present disclosure that is implemented as software modules. In some embodiments, as shown in FIG. 2, the software modules of the device 555 for cluster evaluation stored in the memory 550 may include a clustering processing module 5551, a data determining module 5552, a confidence determining module 5553 and a clustering evaluation module 5554.

The clustering processing module 5551 is configured to perform a clustering operation on a plurality of sample data to obtain a plurality of first clusters.

The data determining module 5552 is configured to, for each first sample data from the plurality of the sample data, determine second sample data whose similarity with the first sample data is greater than a first threshold value from the plurality of the sample data.

The confidence determining module 5553 is configured to determine a confidence of the clustering operation corresponding to each first sample data based on a distribution of the second sample data in each of the first clusters.

The clustering evaluation module 5554 is configured to evaluate the clustering operation based on the confidence corresponding to each first sample data to obtain an evaluation value.

In some embodiments, the clustering evaluation module 5554 is further configured to, for each first sample data from the plurality of the sample data, determine a second cluster in which the first sample data is located from the plurality of first clusters, and determining a weight coefficient of the first sample data based on a distribution of sample data in the second cluster; and fuse a plurality of confidences corresponding to a plurality of the first sample data based on the weight coefficient of each first sample data to obtain the evaluation value.

In some embodiments, the clustering evaluation module 5554 is further configured [00149] to determine a first similarity between each sample data in the second cluster and seed point sample data of the second cluster based on the distribution of the sample data in the second cluster; count a first number of sample data in the second cluster whose first similarities are less than or equal to a second threshold, and count a second number of sample data in the second cluster whose first similarities are greater than the second threshold; and determine the weight coefficient based on the first number, the second number and a second similarity between the first sample data and the seed point sample data.

In some embodiments, the clustering evaluation module 5554 is further configured to: if the second similarity is less than or equal to the second threshold, determine a maximum number of the first number and the second number, and determine a ratio of the maximum number to a third number of sample data included in the second cluster as the weight coefficient; if the second similarity is greater than the second threshold, determine a minimum number of the first number and the second number, and determine a ratio of the minimum number to the third number as the weight coefficient.

In some embodiments, the confidence determining module 5553 is further configured to determine, based on the distribution, a fourth number of second sample data included in each of the first clusters; determine a ratio of the fourth number to a fifth number of sample data included in each of the first clusters as a correlation degree between each first sample data and each of the first clusters; and determine, based on correlation degrees corresponding to each first sample data, the confidence of the clustering operation corresponding to each first sample data.

In some embodiments, the confidence determining module 5553 is further configured to for each of the first clusters, determine a first average similarity between sample data included in the first cluster, and determine, based on the distribution, a second average similarity between the second sample data included in the first cluster and seed point sample data of the first cluster; determine a ratio of the second average similarity to the first average similarity as the correlation degree between each first sample data and each of the first clusters; and determine, based on correlation degrees corresponding to each first sample data, the confidence of the clustering operation corresponding to each first sample data.

In some embodiments, the clustering processing module 5551 is further configured to determine a greatest evaluation value from the evaluation values obtained by evaluating a plurality of clustering operations respectively; and determine a plurality of clusters obtained by the clustering operation corresponding to the greatest evaluation value as a clustering result of the plurality of the sample data.

Embodiments of the present disclosure provide a computer program product including computer programs or computer-executable instructions stored in a computer-readable storage medium. A processor of an electronic device reads the computer-executable instructions or the computer programs from the computer-readable storage medium, and the processor executes the computer-executable instructions or the computer programs, so that the electronic device performs the above-described method for cluster evaluation according to the embodiment of the present disclosure.

Embodiments of the present disclosure provide a computer-readable storage medium having stored thereon computer-executable instructions or computer programs that, when executed by a processor, cause the processor to perform the method for cluster evaluation according to the embodiment of the present disclosure.

The embodiments of the present disclosure have the following beneficial effects. The clustering operation is performed on a plurality of first sample data to obtain a plurality of first clusters; for each first sample data from the plurality of the sample data, second sample data whose similarity with the first sample data is greater than a first threshold value is determined; more accurate evaluation of a correlation degree between the first sample data and each first cluster is implemented through the distribution of the second sample data in each first cluster; and the confidence of performing the clustering operation for each first sample data from the plurality of the sample data is quantified through a plurality of correlation degrees between the first sample data and the plurality of first clusters. On this basis, the clustering operation is evaluated from the dimension of the sample data by considering the confidence corresponding to each first sample data, thereby implementing more comprehensive evaluation of the clustering performance.

In some embodiments, the computer-readable storage medium may be a memory such as the RAM, the ROM, the flash memory, the magnetic surface memory, the optical disc, or the CD-ROM; and may also be various devices including one or any combination of the memories described above.

In some embodiments, the computer-executable instructions may take the form of programs, software, software modules, scripts, or code, may be written in any form of programming language (including compiled languages or interpreted languages, or declarative or procedural languages) and may be deployed in any form, including as standalone programs or as modules, components, subroutines, or other units suitable for use in a computing environment.

As an example, the computer-executable instructions may, but do not necessarily correspond to files in a file system, and may be stored as a part of a file storing other programs or data, e.g., stored in one or more scripts in a Hyper Text Markup Language (HTML) document, stored in a single file dedicated to the discussed program, or stored in multiple collaborative files (e.g., files storing one or more modules, subroutines, or code portions).

As an example, the computer-executable instructions may be deployed to be executed on one electronic device, or on multiple electronic devices located at the same location, or on multiple electronic devices distributed across multiple locations and interconnected through a communication network.

The foregoing contents are merely the embodiments of the present disclosure, and are not intended to limit the scope of protection of the present disclosure. Any modification, equivalent replacement, improvement or the like made within the spirit and scope of the present disclosure is included within the scope of protection of the present disclosure.

1. A method for cluster evaluation, comprising:
performing a clustering operation on a plurality of sample data to obtain a plurality of first clusters;
for each first sample data from the plurality of the sample data, determining second sample data whose similarity with the first sample data is greater than a first threshold value from the plurality of the sample data;
determining a confidence of the clustering operation corresponding to each first sample data based on a distribution of the second sample data in each of the first clusters; and
evaluating the clustering operation based on the confidence corresponding to each first sample data to obtain an evaluation value.

2. The method of claim 1, wherein the evaluating the clustering operation based on the confidence corresponding to each first sample data to obtain an evaluation value comprises:
for each first sample data from the plurality of the sample data, determining a second cluster in which the first sample data is located from the plurality of first clusters, and determining a weight coefficient of the first sample data based on a distribution of sample data in the second cluster; and
fusing a plurality of confidences corresponding to a plurality of the first sample data based on the weight coefficient of each first sample data to obtain the evaluation value.

3. The method of claim 2, wherein the determining a weight coefficient of the first sample data based on a distribution of sample data in the second cluster comprises:
determining a first similarity between each sample data in the second cluster and seed point sample data of the second cluster based on the distribution of the sample data in the second cluster;
counting a first number of sample data in the second cluster whose first similarities are less than or equal to a second threshold, and counting a second number of sample data in the second cluster whose first similarities are greater than the second threshold; and
determining the weight coefficient based on the first number, the second number and a second similarity between the first sample data and the seed point sample data.

4. The method of claim 3, wherein the determining the weight coefficient based on the first number, the second number and a second similarity between the first sample data and the seed point sample data comprises:
when the second similarity is less than or equal to the second threshold, determining a maximum number of the first number and the second number, and determining a ratio of the maximum number to a third number of sample data included in the second cluster as the weight coefficient; and
when the second similarity is greater than the second threshold, determining a minimum number of the first number and the second number, and determining a ratio of the minimum number to the third number as the weight coefficient.

5. The method of claim 1, wherein the determining a confidence of the clustering operation corresponding to each first sample data based on a distribution of the second sample data in each of the first clusters comprises:
determining, based on the distribution, a fourth number of second sample data included in each of the first clusters;
determining a ratio of the fourth number to a fifth number of sample data included in each of the first clusters as a correlation degree between each first sample data and each of the first clusters; and
determining, based on correlation degrees corresponding to each first sample data, the confidence of the clustering operation corresponding to each first sample data.

6. The method of claim 1, wherein the determining a confidence of the clustering operation corresponding to each first sample data based on a distribution of the second sample data in each of the first clusters comprises:
for each of the first clusters, determining a first average similarity between sample data included in the first cluster, and determining, based on the distribution, a second average similarity between the second sample data included in the first cluster and seed point sample data of the first cluster;
determining a ratio of the second average similarity to the first average similarity as a correlation degree between each first sample data and each of the first clusters; and
determining, based on correlation degrees corresponding to each first sample data, the confidence of the clustering operation corresponding to each first sample data.

7. The method of claim 1, further comprising:
determining a greatest evaluation value from the evaluation values obtained by evaluating a plurality of clustering operations respectively; and
determining a plurality of clusters obtained by the clustering operation corresponding to the greatest evaluation value as a clustering result of the plurality of the sample data.

8. An electronic device, comprising:
a memory, configured to store computer-executable instructions or computer programs; and
a processor, configured to execute computer-executable instructions stored in the memory to perform operations of:
performing a clustering operation on a plurality of first sample data to obtain a plurality of first clusters;
for each first sample data from the plurality of the sample data, determining second sample data whose similarity with the first sample data is greater than a first threshold value from the plurality of the sample data;
determining a confidence of the clustering operation corresponding to each first sample data based on a distribution of the second sample data in each of the first clusters; and
evaluating the clustering operation based on the confidence corresponding to each first sample data to obtain an evaluation value.

9. The electronic device of claim 8, wherein the evaluating the clustering operation based on the confidence corresponding to each first sample data to obtain an evaluation value comprises:
for each first sample data from the plurality of the sample data, determining a second cluster in which the first sample data is located from the plurality of first clusters, and determining a weight coefficient of the first sample data based on a distribution of sample data in the second cluster; and
fusing a plurality of confidences corresponding to a plurality of the first sample data based on the weight coefficient of each first sample data to obtain the evaluation value.

10. The electronic device of claim 9, wherein the determining a weight coefficient of the first sample data based on a distribution of sample data in the second cluster comprises:
determining a first similarity between each sample data in the second cluster and seed point sample data of the second cluster based on the distribution of the sample data in the second cluster;
counting a first number of sample data in the second cluster whose first similarities are less than or equal to a second threshold, and counting a second number of sample data in the second cluster whose first similarities are greater than the second threshold; and
determining the weight coefficient based on the first number, the second number and a second similarity between the first sample data and the seed point sample data.

11. The electronic device of claim 10, wherein the determining the weight coefficient based on the first number, the second number and a second similarity between the first sample data and the seed point sample data comprises:
when the second similarity is less than or equal to the second threshold, determining a maximum number of the first number and the second number, and determining a ratio of the maximum number to a third number of sample data included in the second cluster as the weight coefficient; and
when the second similarity is greater than the second threshold, determining a minimum number of the first number and the second number, and determining a ratio of the minimum number to the third number as the weight coefficient.

12. The electronic device of claim 8, wherein the determining a confidence of the clustering operation corresponding to each first sample data based on a distribution of the second sample data in each of the first clusters comprises:
determining, based on the distribution, a fourth number of second sample data included in each of the first clusters;
determining a ratio of the fourth number to a fifth number of sample data included in each of the first clusters as a correlation degree between each first sample data and each of the first clusters; and
determining, based on correlation degrees corresponding to each first sample data, the confidence of the clustering operation corresponding to each first sample data.

13. The electronic device of claim 8, wherein the determining a confidence of the clustering operation corresponding to each first sample data based on a distribution of the second sample data in each of the first clusters comprises:
for each of the first clusters, determining a first average similarity between sample data included in the first cluster, and determining, based on the distribution, a second average similarity between the second sample data included in the first cluster and seed point sample data of the first cluster;
determining a ratio of the second average similarity to the first average similarity as a correlation degree between each first sample data and each of the first clusters; and
determining, based on correlation degrees corresponding to each first sample data, the confidence of the clustering operation corresponding to each first sample data.

14. The electronic device of claim 8, wherein the processor is configured to execute computer-executable instructions stored in the memory to perform further operations of:
determining a greatest evaluation value from the evaluation values obtained by evaluating a plurality of clustering operations respectively; and
determining a plurality of clusters obtained by the clustering operation corresponding to the greatest evaluation value as a clustering result of the plurality of the sample data.

15. A non-transitory computer-readable storage medium having stored thereon computer-executable instructions that, when executed by a processor, cause the processor to perform operations of:
performing a clustering operation on a plurality of first sample data to obtain a plurality of first clusters;
for each first sample data from the plurality of the sample data, determining second sample data whose similarity with the first sample data is greater than a first threshold value from the plurality of the sample data;
determining a confidence of the clustering operation corresponding to each first sample data based on a distribution of the second sample data in each of the first clusters; and
evaluating the clustering operation based on the confidence corresponding to each first sample data to obtain an evaluation value.

16. The non-transitory computer-readable storage medium of claim 15, wherein the evaluating the clustering operation based on the confidence corresponding to each first sample data to obtain an evaluation value comprises:
for each first sample data from the plurality of the sample data, determining a second cluster in which the first sample data is located from the plurality of first clusters, and determining a weight coefficient of the first sample data based on a distribution of sample data in the second cluster; and
fusing a plurality of confidences corresponding to a plurality of the first sample data based on the weight coefficient of each first sample data to obtain the evaluation value.

17. The non-transitory computer-readable storage medium of claim 16, wherein the determining a weight coefficient of the first sample data based on a distribution of sample data in the second cluster comprises:
determining a first similarity between each sample data in the second cluster and seed point sample data of the second cluster based on the distribution of the sample data in the second cluster;
counting a first number of sample data in the second cluster whose first similarities are less than or equal to a second threshold, and counting a second number of sample data in the second cluster whose first similarities are greater than the second threshold; and
determining the weight coefficient based on the first number, the second number and a second similarity between the first sample data and the seed point sample data.

18. The non-transitory computer-readable storage medium of claim 17, wherein the determining the weight coefficient based on the first number, the second number and a second similarity between the first sample data and the seed point sample data comprises:
when the second similarity is less than or equal to the second threshold, determining a maximum number of the first number and the second number, and determining a ratio of the maximum number to a third number of sample data included in the second cluster as the weight coefficient; and
when the second similarity is greater than the second threshold, determining a minimum number of the first number and the second number, and determining a ratio of the minimum number to the third number as the weight coefficient.

19. The non-transitory computer-readable storage medium of claim 15, wherein the determining a confidence of the clustering operation corresponding to each first sample data based on a distribution of the second sample data in each of the first clusters comprises:
determining, based on the distribution, a fourth number of second sample data included in each of the first clusters;
determining a ratio of the fourth number to a fifth number of sample data included in each of the first clusters as a correlation degree between each first sample data and each of the first clusters; and
determining, based on correlation degrees corresponding to each first sample data, the confidence of the clustering operation corresponding to each first sample data.

20. The non-transitory computer-readable storage medium of claim 15, wherein the determining a confidence of the clustering operation corresponding to each first sample data based on a distribution of the second sample data in each of the first clusters comprises:
for each of the first clusters, determining a first average similarity between sample data included in the first cluster, and determining, based on the distribution, a second average similarity between the second sample data included in the first cluster and seed point sample data of the first cluster;
determining a ratio of the second average similarity to the first average similarity as a correlation degree between each first sample data and each of the first clusters; and
determining, based on correlation degrees corresponding to each first sample data, the confidence of the clustering operation corresponding to each first sample data.
